(19) United States
(12) Patent Application Publication
(10) Pub. No.: US 2007/0057885 A1
(43) Pub. Date: Mar. 15, 2007

(54) ELECTRO-OPTICAL DEVICE, METHOD OF DRIVING ELECTRO-OPTICAL DEVICE, AND ELECTRONIC APPARATUS

(75) Inventors: Takashi KURUMISAWA, Suwa-shi, Nagano-ken (JP); Hidekuni MORIYA, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/468,623

(22) Filed: Aug. 30, 2006

(30) Foreign Application Priority Data
Sep. 13, 2005 (JP) 2005-264866
Oct. 18, 2005 (JP) 2005-302777

(51) Int. Cl. G09G 3/36

(52) U.S. Cl. 345/89

(57) ABSTRACT

An electro-optical device includes: a plurality of scanning lines; a plurality of data lines; and a plurality of pixels that are provided at positions corresponding to intersections of the scanning lines and the data lines and include pixels each having a red color filter and pixels each having a blue color filter. A plurality of frames are set as a reference frame, the pixels are displayed with either a first gray-scale or a second gray-scale whose level is higher than that of the first gray-scale by one gray-scale level, in each frame, and image signals are supplied to the plurality of data lines such that adjacent pixels nave phases opposite to each other at a spatial frequency among the pixels each having the red color filter and the pixels each having the blue color filter.

### BACKGROUND

1. Technical Field

The present invention relates to an electro-optical device using an electro-optical material, such as liquid crystal, to a method of driving the electro-optical device, and to an electronic apparatus having the electro-optical device.

2. Related Art

Electro-optical devices, such as liquid crystal devices, which display images, have been known. An electro-optical device includes a first substrate, a second substrate provided to face the first substrate, and liquid crystal provided between the first and second substrates so as to control the light emitted from a backlight. The first substrate has a backlight, a plurality of scanning lines, a plurality of data lines, and a plurality of pixel electrodes and switching elements that are provided at positions corresponding to intersections of the scanning lines and the data lines.

In the electro-optical device, a display region, which is composed of a plurality of pixels that are provided at positions corresponding to the plurality of pixel electrodes and switching elements, is formed. Further, the plurality of pixels includes pixels each having a red (R) color filter, pixels each having a green (G) color filter, and pixels each having a blue (B) color filter.

According to the above-described electro-optical device, image signals are supplied to three kinds of pixels so as to control a liquid crystal shutter. When light is emitted from the backlight, the light passes through the liquid crystal shutter controlled by the pixels and is then irradiated on the entire surface of the display region. The light incident on each pixel of the display region passes through the corresponding color filter and is then emitted.

In recent years, the color reproducibility of electro-optical devices has been required to be improved. The following methods of improving color reproducibility are known to meet such a demand.

First, an electro-optical device that has four kinds of pixels through the addition of an extra color filter to those described above is known (refer to JP-A-2002-006303). According to the electro-optical device, having four kinds of pixels allows a larger color gamut, which makes it possible to improve color reproducibility.

Second, a method is known in which the lighting time of pixels per frame is determined so as to display an intermediate gray-scale level.

That is, a liquid crystal panel is composed of pixels that can display two kinds of gray-scales (first and second gray-scales). Then, the plurality of pixels are put together into one block, and the pixels included in the block are divided into first and second groups. Further, the pixels belonging to the first group are turned on with the first or second gray-scale over a reference period, and the pixels belonging to the second group are turned on with any one of the first and second gray-scales (for example, refer to JP-A-2003-122312).

According to the electro-optical device using the method of displaying an intermediate gray-scale level described in JP-A-2003-122312, multiple-gray-scale display can be performed by changing the gray-scale levels of the respective pixels and controlling the lighting time of the pixels included in the block, without increasing the number of basic display gray-scales. Therefore, it is possible to improve the color reproducibility.

In recent years, color reproducibility has been required to be further improved.

Accordingly, a method is considered in which the number of kinds of color filters corresponding to pixels is four and the lighting time of the pixels per frame is determined so as to display an intermediate gray-scale. In this case, however, when only the lighting time of four kinds of pixels per frame is determined, a problem arises in that flickering or color phase irregularity can occur.

### SUMMARY

An advantage of some aspects of the invention is that it provides an electro-optical device that can further improve color reproducibility while suppressing flickering and irregular coloring, a method of driving the electro-optical device, and an electronic apparatus.

According to an aspect of the invention, an electro-optical device includes: a plurality of scanning lines; a plurality of data lines; and a plurality of pixels that are provided at positions corresponding to intersections of the scanning lines and the data lines, the plurality of pixels including pixels each having a red color filter and pixels each having a blue color filter. A plurality of frames are set as a reference frame. The pixels are displayed with either a first gray-scale or a second gray-scale whose level is higher than that of the first gray-scale by one grays scale level, in each frame. Image signals are supplied to the plurality of data lines such that adjacent pixels have phases opposite to each other at a spatial frequency among the pixels each having the red color filter and the pixels each having the blue color filter.

According to this structure, the plurality of pixels are composed of the pixels each having a red color filter and the pixels each having a blue color filter, and the respective pixels are displayed with the first or second gray-scale in each frame forming the reference frame. Therefore, in terms of the reference frame, an intermediate gray-scale between the first and second gray-scales can be displayed, which makes it possible to improve color reproducibility.

Furthermore, the image signals are supplied so that the adjacent pixels of the pixels, each having the red color filter, and the pixels, each having the blue color filter, have phases opposite to each other at a spatial frequency.

The phases opposite to each other on the spatial frequency can be explained as follows. When pixels each having a red color filter are displayed with a predetermined gray-scale and pixels each having a blue color filter are displayed with a gray-scale different from that of a predetermined frame forming the reference frame, the pixels each having the red color filter and the pixels each having the blue color filter are displayed in continuous frames, with the gray-scale levels of the previous frame being switched.

Therefore, it is possible to prevent flickering and irregular coloring from occurring.

According to another aspect of the invention, an electro-optical device includes: a plurality of scanning lines; a plurality of data lines; and a plurality of pixels that are provided at positions corresponding to intersections of the scanning lines and the data lines, the plurality of pixels including pixels each having a green color filter and pixels each having a cyan color filter. A plurality of frames are set as a reference frame, the pixels are displayed with either a first gray-scale or a second gray-scale whose level is higher than that of the first gray-scale by one gray-scale level, in each frame, and image signals are supplied to the plurality of data lines such that adjacent pixels have phases opposite to each other at a spatial frequency among the pixels each having the green color filter and the pixels each having the cyan color filter.

According to this structure, the image signals are supplied such that adjacent pixels have phases opposite to each other at a spatial frequency among the pixels each having the green color filter and the pixels each having the cyan color filter. Therefore, it is possible to suppress flickering and irregular coloring from occurring.

In the electro-optical device according to this aspect, preferably, the plurality of pixels further include pixels each having a red color filter and pixels each having a blue color filter, and image signals are supplied to the plurality of data lines such that adjacent pixels have phases opposite to each other at a spatial frequency among the pixels each having the red color filter and the pixels each having the blue color filter.

According to this structure, the image signals are supplied to the plurality of data lines such that adjacent pixels have phases opposite to each other at a spatial frequency among the pixels each having the red color filter and the pixels each having the blue color filter. Further, the image signals are supplied to the plurality of data lines such that adjacent pixels have phases opposite to each other at a spatial frequency among the pixels each having a green color filter and the pixels each having a cyan color filter.

Therefore, it is possible to prevent flickering and irregular color.

According to another aspect of the invention, an electronic apparatus includes the above-described electro-optical device.

According to this structure, the same effects as described above can be obtained.

According to still another aspect of the invention, there is provided a method of driving an electro-optical device having a plurality of scanning lines, a plurality of data lines, and a plurality of pixels that are provided at positions corresponding to intersections of the scanning lines and the data lines and include pixels each having a red color filter and pixels each having a blue color filter. The method includes: supplying image signals to the plurality of data lines such that adjacent pixels have phases opposite to each other at a spatial frequency among the pixels each having the red color filter and the pixels each having the blue color filter. A plurality of frames are set as a reference frame, and the pixels are displayed with either a first gray-scale or a second gray-scale whose level is higher than that of the first gray-scale by one gray-scale level, in each frame.

According to this aspect, it is possible to obtain the same effects as described above.

According to still another aspect of the invention, there is provided a method of driving an electro-optical device having a plurality of scanning lines, a plurality of data lines, and a plurality of pixels that are provided at positions corresponding to intersections of the scanning lines and the data lines and include pixels each having a green color filter and pixels each having a cyan color filter. The method includes: supplying image signals to the plurality of data lines such that adjacent pixels have phases opposite to each other at a spatial frequency among the pixels each having the green color filter and the pixels each having the cyan color filter. A plurality of frames are set as a reference frame, and the pixels are displayed with either a first gray-scale or a second gray-scale whose level is higher then that of the first gray-scale by one gray-scale level, in each frame.

According to this aspect, it is possible to obtain the same effects as described above.

In the method of driving an electro-optical device according to this aspect, preferably, the plurality of pixels further include pixels each having a red color filter and pixels each having a blue color filter, and image signals are supplied to the plurality of data lines such that adjacent pixels have phases opposite to each other at a spatial frequency among the pixels each having the red color filter and the pixels each having the blue color filter.

According to this aspect, it is possible to obtain the same effects as described above.

### BRIEF DESCRIPTION OF THE DRAWINGS

The invention will be described with reference to the accompanying drawings, wherein like numbers reference like elements, and wherein:

FIG. 1 is a block diagram showing the configuration of an electro-optical device according to an embodiment of the invention.

FIG. 2 is a block diagram showing the construction of an X driver of the electro-optical device.

FIG. 3 is a view schematically illustrating the arrangement of pixels of the electro-optical device.

FIG. 4 is a view schematically illustrating a lighting pattern of pixels having a red (R) color filter for each frame in the electro-optical device.

FIG. 5 is a view schematically illustrating a lighting pattern of pixels having a red (R) color filter for each column in the electro-optical device.

FIG. 6 is a view schematically illustrating a lighting pattern of pixels having a blue (B) color filter for each frame in the electro-optical device.

FIG. 7 is a view schematically illustrating a lighting pattern of pixels having a blue (B) color filter for each column in the electro-optical device.

FIG. 8 is a view schematically illustrating a lighting pattern of pixels having a green (G) color filter for each frame in the electro-optical device.

FIG. 9 is a view schematically illustrating a lighting pattern of pixels having a green (G) color filter for each column in the electro-optical device.

FIG. 10 is a view schematically illustrating a lighting pattern of pixels having a cyan (C) color filter for each frame in the electro-optical device.

FIG. 11 is a view schematically illustrating a lighting pattern of pixels having a cyan (C) color filter for each column in the electro-optical device.

FIG. 12 is a perspective view showing the construction of a mobile phone to which the electro-optical device is applied.

### DESCRIPTION OF EXEMPLARY EMBODIMENTS

Hereinafter, preferred embodiments of the invention will be described with reference to the accompanying drawings. Moreover, in the following embodiment and modified embodiment, components of the first embodiment that are the same as those of the modified embodiment are denoted by the same reference numerals, and a description thereof will be omitted.

### Embodiment

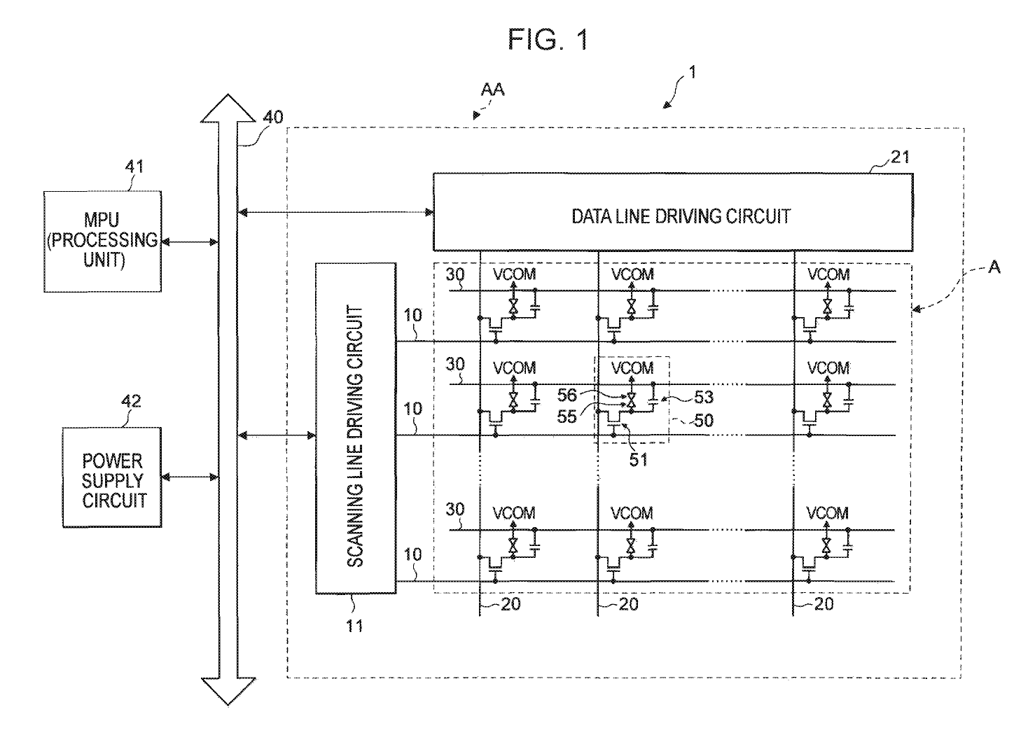

FIG. 1 is a block diagram illustrating an electro-optical device 1 according to a first embodiment of the invention.

The electro-optical device 1 includes a liquid crystal panel AA, a scanning line driving circuit 11 and a data line driving circuit 21 that drive the liquid crystal panel AA, an MPU (microprocessor unit) 41, and a power supply circuit 42.

The MPU 41 is connected to an external bus 40 and controls the scanning line driving circuit 11, the data line driving circuit 21, and the power supply circuit 42.

Specifically, the MPU 41 supplies vertical synchronization signals and horizontal synchronization signals to the scanning line driving circuit 11 and the data line driving circuit 21, and issues various commands to those circuits. Further, the MPU 41 sets the voltage level of the power supplied to the power supply circuit 42.

On the basis of a reference voltage supplied from the outside, the power supply circuit 42 generates various power supply voltages required for driving the liquid crystal panel AA and then supplies the generated power supply voltages to the scanning line driving circuit 11 and the data line driving circuit 21.

The liquid crystal panel AA includes a plurality of scanning lines 10, a plurality of data lines 20, and pixel circuits 50 provided at positions corresponding to intersections of the scanning lines 10 and the data lines 20.

In the liquid crystal panel AA, a display region A, which is composed of a plurality of pixels provided at positions corresponding to the plurality of pixel circuits 50, is formed.

The scanning line driving circuit 11 and the data line driving circuit 21 are formed on an element substrate of the liquid crystal panel AA.

Each of the pixel circuits 50 includes a TFT 51, a pixel electrode 55, a storage capacitor 53, which are provided on the element substrate, and a common electrode 56 provided in a counter electrode.

Specifically, the element substrate includes the plurality of scanning lines 10 and common lines 30 that are alternately disposed at predetermined distances, the plurality of data lines 20 that are substantially orthogonal to the scanning lines 10 and are provided at predetermined distances, the TFTs 51, serving as switching elements provided at positions corresponding to the intersections of the scanning lines 10 and the data lines 20, the pixel electrodes 55, and the storage capacitors 53 each storage capacitor having one end electrically connected to a corresponding pixel electrode 55 and the other end electrically connected to a corresponding common line 30.

The counter substrate includes four kinds (red (R), green (G), blue (B), and cyan (C)) of color filters provided in a matrix and a common electrode 56 facing the pixel electrodes 55. The common electrode 56 is connected to the common lines 30.

Further, liquid crystal is interposed between the pixel electrodes 55 provided in the element substrate and the common electrode 56 provided on the counter substrate.

The gate electrode of the TFT 51 is connected to the scanning line 10, the source electrode is connected to the data line 20, and the drain electrode is connected to the pixel electrode 55 and the storage capacitor 53. Therefore, when a selection voltage from the scanning line 10 is applied to the TFT 51, the data line 20, the pixel electrode 55, and the storage capacitor 53 are electrically connected.

The scanning line driving circuit 11 sequentially supplies a selection voltage to the respective scanning lines 10, the selection voltage turning on the TFT 51. For example, if a selection voltage is supplied to a predetermined scanning line 10, all of the TFTs 51 connected to the scanning line 10 are turned on, and all of the pixel electrodes 50 connected to the scanning line 10 are selected.

The data line driving circuit 21 supplies an image signal to the respective data lines 20, and sequentially writes image data into the pixel electrodes 55 of the pixel circuits 50 by the TFTs 51 that are turned on. Here, the data line driving circuit 21 alternately performs positive writing and negative writing, with the voltage of the common electrode 56 as a reference voltage. In the positive writing, an image signal is supplied to the data line 20 at a voltage higher than that of the common electrode 56. In the negative writing, an image signal is supplied to the data line 20 at a voltage lower than that of the common electrode 56.

The scanning line driving circuit 11 includes a Y driver (not shown) that generates a selection voltage to be applied to the scanning line 10. Further, the data line driving circuit 21 includes four kinds of X drivers 21A corresponding to four kinds (red (R), green (G), blue (B), and cyan (C)) of pixels. The X drivers 21A will be described below.

The above-described electro-optical device 1 operates as follows.

When a selection voltage is sequentially supplied, all or the pixel circuits 50 connected to the predetermined scanning line 10 are selected. Further, in synchronization with the selection of these pixel electrodes 50, image signals are supplied to the data lines 20. Then, the image signals are supplied to all of the pixel electrodes 50 selected by the scanning line driving circuit, and image data is written into the pixel electrodes 55.

Here, the electro-optical device 1 alternately performs positive writing and negative writing, with the voltage of the common electrode 56 as a reference voltage. In the positive writing, an image signal is supplied to the data line 20 at a voltage higher than that of the common electrode 56. In the negative writing, an image signal is supplied to the data line 20 at a voltage lower than that of the common electrode 50.

If image data is written into the pixel electrode 55 of the pixel circuit 50, a driving voltage is applied to the liquid crystal due to a potential difference between the pixel electrode 55 and the common electrode 56. Therefore, if the voltage level of the image signal is changed, the orientation or order of the liquid crystal is changed, and thus gray-scale display using light modulation of each pixel is performed.

In addition, the driving voltage applied to the liquid crystal is retained by the storage capacitor 53 for a period OF time that is three orders of magnitude longer than a period of time for which image data is written.

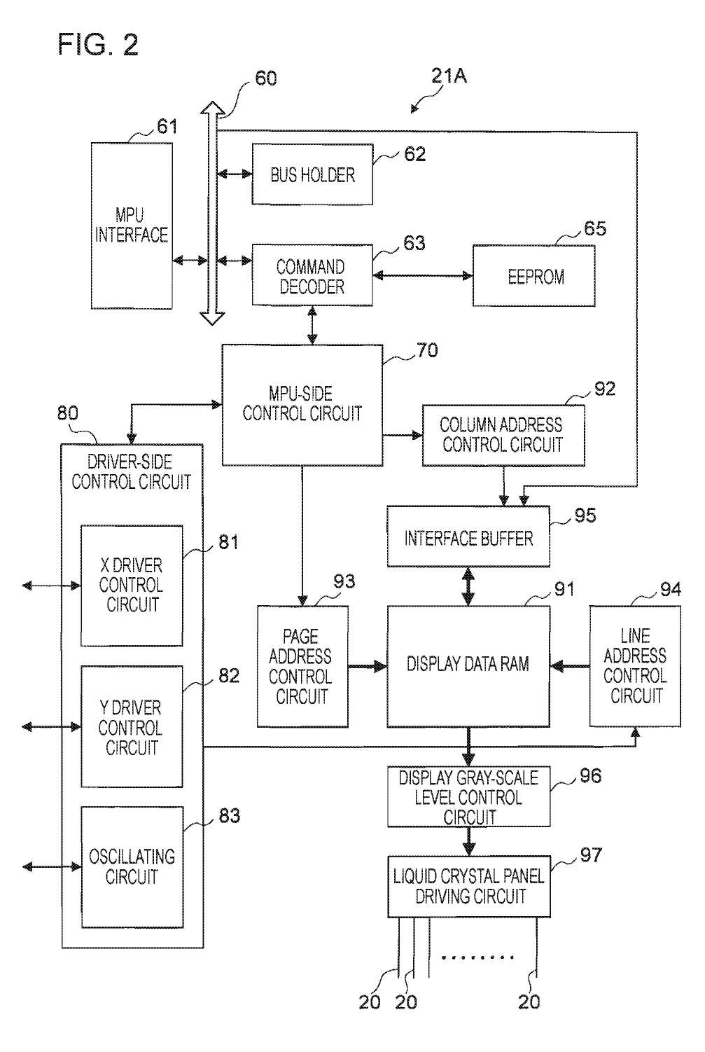

FIG. 2 is a block diagram illustrating the X driver 21A included in the data line driving circuit 21. Even though one type of X driver 21A will be described below, the other three types of X drivers 21A have the same configuration.

The X driver 21A includes an internal bus 60, an MPU interface 61 connected to the internal bus 60, a bus holder 62, a command decoder 63, and an MPU-side control circuit 70.

The MPU interface 61 is connected to the above-described MPU 41.

The bus holder 62 temporarily holds data on the internal bus 60.

The command decoder 63 decodes a command input from the MPU 41 and then outputs the decoded result to the MPU-side control circuit 70.

The command decoder 63 is connected to an EEPROM 65 serving as a non-volatile memory. The EEPROM 65 stores display characteristic control parameters (such as a contrast adjusting parameter, a display control parameter, a gray-scale control parameter and the like). The display characteristic control parameters are read, for example, at the time of power connection, system reset, and refresh timing, and are then reflected as parameters of the MPU-side control circuit 70, a driver-side control circuit 80 and the like.

When display data on the four kinds (red (R), green (G), blue (B), and cyan (C)) of pixels is input, the MPU-side control circuit 70 controls the driver-side control circuit 80, a column address control circuit 92, and a page address control circuit 93. Further, the MPU-side control circuit 70 not only reads/writes the display data from/into a display data RAM 91, but also controls a display gray-scale level control circuit 96.

The column address control circuit 92 designates a write column address of display data with respect to the display data RAM 91 through an interface buffer 95.

The page address control circuit 93 designates write and read page addresses of display data with respect to the display data RAM 91.

The driver-side control circuit 80 that controls a line address control circuit 94 includes an X driver control circuit 81, a Y driver control circuit 82, and an oscillating circuit 83.

The X driver control circuit 81 is synchronized with the other three types of X drivers 21A.

The Y driver control circuit 82 controls the line address control circuit 94.

The oscillating circuit 83 generates a reference clock used within the X driver 21A. Since the main purpose is to control display of an image, the frequency of the reference clock is about several hundred KHz.

The line address control circuit 94 designates a read address of display data with respect to the display data RAM 91.

while the X driver control circuit 81 is synchronized with a driver-side control circuit 80 of the other three types of X drivers 21A, the driver-side control circuit 80 controls the line address control circuit 94, and controls a read operation with respect to the display data RAM 91 together with the MPU-side control circuit 70.

The above X driver 21A operates as follows.

On the basis of the command decoded by the command decoder 63, the MPU-side control circuit 70 writes display data into the address of the display data RAM 91 designated by the column address control circuit 92 and the page address control circuit 93 through the interface buffer 95.

The MPU-side control circuit 70 reads display data, which is written into the display data RAM 91, from the address designated by the page address control circuit 93 and the line address control circuit 94 and then outputs the read display data to the display gray-scale level control circuit 96.

On the basis of the display data input from the display data RAM 91, the display gray-scale level control circuit 96 performs FRC (Frame Rate Control), which will be described below, and outputs an image signal to a liquid crystal panel driving circuit 97.

The liquid crystal panel driving circuit 97 increases the voltage of the image signal, which is input from the display gray-scale level control circuit 96, up to a voltage corresponding to the voltage of the liquid crystal panel AA, and supplies the increased voltage to the data line 20 of the liquid crystal panel AA.

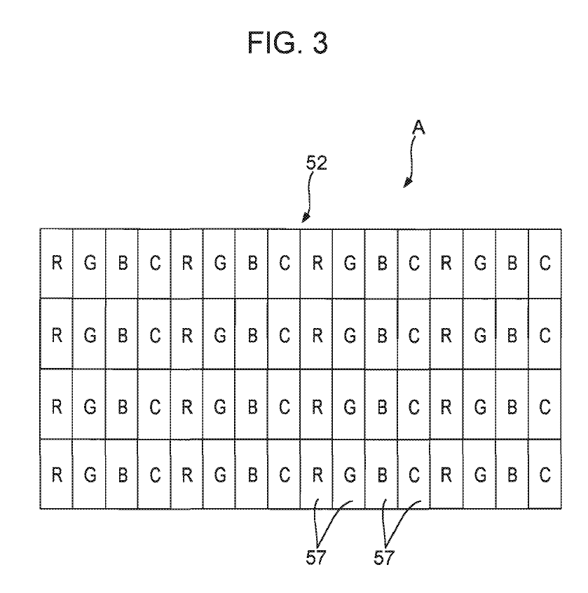

FIG. 3 is a view schematically illustrating a display region A.

The display region A has a plurality of pixels 57 arranged in a matrix. The plurality of pixels 57 include pixels 57 having a red (R) color filter, pixels 57 having a green (G) color filter, pixels 57 having a blue (B) color filter, and pixels 57 having a cyan (C) color filter.

As described above, the pixels 57 are composed of four kinds (red (R), green (G), blue (B), and cyan (C)) of pixels. Subsequently, the four kinds of pixels 57 disposed in the horizontal direction of FIG. 3 are considered as one set. Further, a pixel block 52 is obtained by arranging four sets of pixels 57 vertically and horizontally (total of 16 sets),

In the present embodiment, four kinds of pixels 57 are arranged in a stripe pattern, as shown in FIG. 3.

First, FPC that is performed on the red (R) pixel 57 and the blue (B) pixel 57 by the display gray-scale level control circuit 96 will be described.

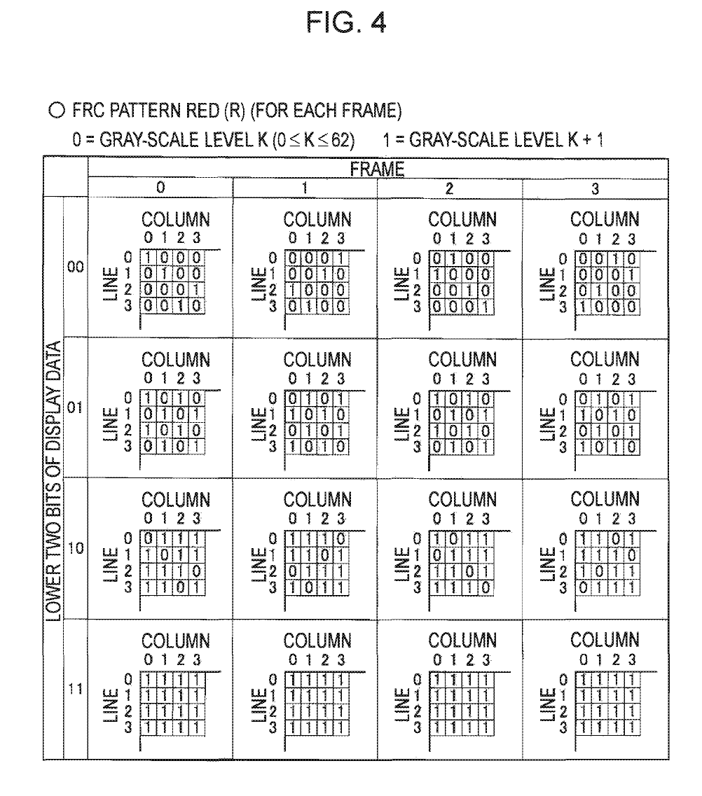

FIG. 4 is a view schematically illustrating a lighting pattern of 16 red (R) pixels 57 among all of the pixels 57 included in the pixel block 52, for each frame.

In FIG. 4, the vertical axis indicates a gray-scale level that is represented using low-order two bits of 8-bit display data.

The horizontal axis indicates the frame number. If the frame number goes up to ‘3’ from ‘0’, it returns to ‘0’.

The pixel block 52 of FIG. 4 includes 16 (4×4) red (R) pixels 57 that are represented by four (zeroth to third) lines and four (zeroth to third) columns.

Hereinafter, positions of these 16 red (R) pixels 57 within the pixel block 52 are represented by (x, y) (x is the column number, and y is the line number). In the pixel block 52, one-grayscale display is made by selectively lighting up the 16 red (R) pixels 57.

In the pixel block 52, the pixel 57 of ‘0’ is lit with a gray-scale level K (here, 0≦K≦62), and the pixel 57 of ‘1’ is lit with a gray-scale level K+1.

For example, when low-order two bits of display data are ‘00’ and the frame number is ‘0’, the 16 red (R) pixels 57 of the pixel block 52 are turned on as follows.

That is, the red (R) pixels 57 at (0, 0), (1, 1), (2, 3), and (3, 2) are turned on with the gray-scale level K+1 and the remaining red (R) pixels 57 are turned on with the gray-scale level.

When the frame switches so that the frame number is ‘1’, the red (R) pixels 57 at (0, 2), (1, 3), (2, 1), and (3, 0) are turned on with the gray-scale level K+1, and the remaining red (R) pixels 57 are turned on with the gray-scale level K.

When the frame switches so that the frame number is ‘2’, the red (R) pixels 57 at (0, 1) (1, 0), (2, 2), and (3, 3) are turned on with the gray-scale level K+1, and the remaining red (R) pixels 57 are turned on with the gray-scale level K.

When the frame switches so that the frame number is ‘3’, the red (R) pixels 57 at (0, 3), (1, 2), (2, 0), and (3, 1) are turned on with the gray-scale level K+1, and the remaining red (R) pixels 57 are turned on with the gray-scale level K.

If the frame further switches, the frame number returns to ‘0’, the red (R) pixels 57 are turned on as in the case where low-order two bits of the display data are ‘00’ and the frame number is ‘0’.

As such, when low-order two bits of display data are ‘00’, the pixel block 52 composed of the 16 red (R) pixels 57 displays red (R) with a gray-scale level K+¼, which is an intermediate gray-scale level between the gray-scale levels K and K+1.

Similarly, when low-order two bits of display data are ‘01’, the pixel block 52 composed of the 16 red (R) pixels 57 displays red (R) with a gray-scale level K+½, which is an Intermediate gray-scale level between the gray-scale levels K and K+1.

Similarly, when low-order two bits of display data are ‘10’, the pixel block 52 composed of the 16 red (R) pixels 57 displays red (R) with a gray-scale level K+¾ which is an intermediate gray-scale level between the gray-scale levels K and K+1.

Similarly, when low-order two bits of display data are ‘11’, the pixel block 52 composed of the 16 red (R) pixels 57 displays red (R) with a gray-scale level K+1.

As such, the electro-optical device 1 switches the lighting pattern for each frame so as to perform FRC, thereby displaying red (R) with an intermediate gray-scale level between the gray-scale levels K and K+1. In the lighting pattern, the 16 red (R) pixels 57 included in the pixel block 52 are turned on with the gray-scale levels K and K+1.

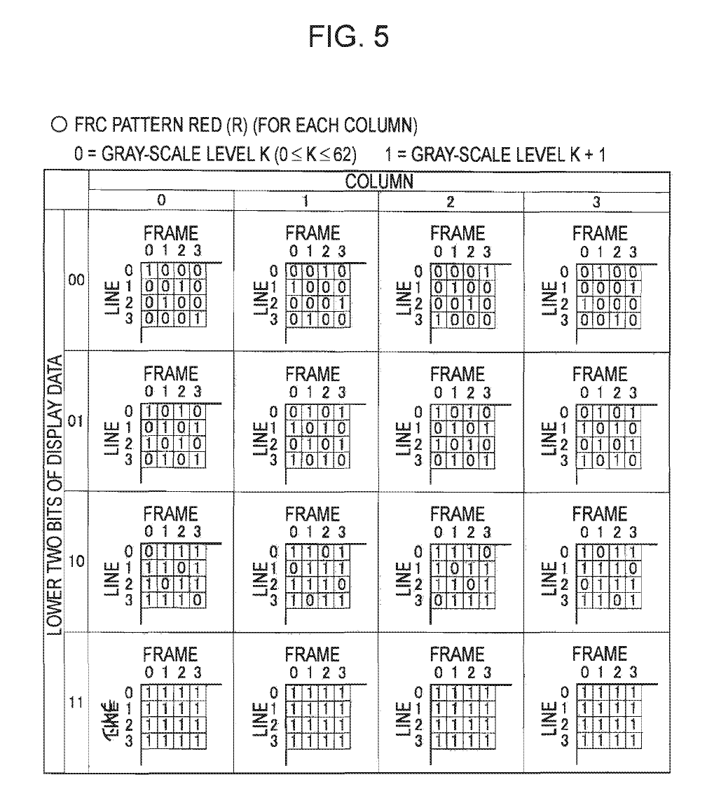

FIG. 5 is a view schematically illustrating the lighting pattern of the 16 red (B) pixels 57 among the pixels 57 included in the pixel block 52, for each column.

The 16 red (R) pixels 57 have been represented for each frame in FIG. 4, while the 16 red (R) pixels 57 are represented for each column in FIG. 5.

In FIG. 5, the horizontal axis indicates the column number, that is, four (zeroth to third) columns.

The pixel block 52 of FIG. 5 includes 16 (4×4) red (R) pixels 57 that are represented by four (zeroth to third) lines and four (zeroth to third) columns.

Hereinafter, the positions of these 16 red (R) pixels 57 within the pixel block 52 are represented by [x, y] (x is the frame number, and y is the line number). In the pixel block 52, one-gray-scale display is made by selectively lighting up the 16 red (R) pixels 57.

As described above, even though the representation methods are different, FIGS. 4 and 5 depict the same lighting pattern of the 16 red (R) pixels 57.

In FIG. 5, when low-order two bits of display data are ‘00’ and the column number is ‘0’, the red (R) pixels 57 at [0, 0], [1, 2], [2, 1], and [3, 3] are turned on with the gray-scale level K+1. The positions of these pixels 57 correspond to (0, 0) when low-order two bits of display data are ‘00’, and the column number is ‘0’, (0, 2) when low-order two bits of display data are ‘00’ and the column number is ‘1’, (0, 1) when low-order two bits of display data are ‘00’ and the column number is ‘2’, and (0, 3) when low-order two bits of display data are ‘00’ and the column number is ‘3’, in FIG. 4.

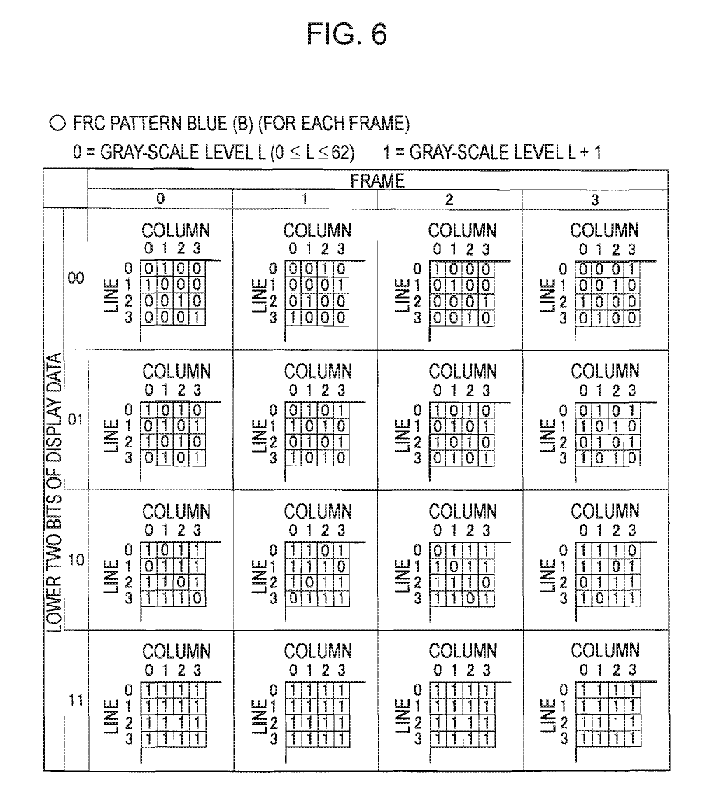

FIG. 6 is a view schematically illustrating a lighting pattern of 16 blue pixels 57 among the pixels 57 included in the pixel block 52, for each frame.

In FIG. 6, the vertical axis indicates a gray-scale level represented by using low-order two bits of 8-bit display data, and the horizontal axis indicates the frame number. The frame number is synchronized with the frame number of FIG. 4.

The pixel block 52 of FIG. 6 includes 16 (4×4) blue (B) pixels 57 represented by four (zeroth to third) lines and four (zeroth to third) columns.

Hereinafter, positions of these 16 blue (B) pixels 57 within the pixel block 52 are represented by (x, y) (x is the column number, and y is the line number). In the pixel block 52, one-grayscale display is made by selectively lighting up the 16 blue (B) pixels 57.

In the pixel block 52, the pixel 57 of ‘0’ is turned on with a gray-scale level L (0≦L≦62), and the pixel 57 of ‘1’ is turned on with a gray-scale level L+1 (here, 0≦L≦62).

For example, when low-order two bits of display data are ‘00’ and the frame number is ‘0’, the 16 blue (B) pixels 57 of the pixel block 52 are turned on as follows.

That is, the blue (B) pixels 57 at (0, 1), (1, 0), (2, 2), and (3, 3) are turned on with the gray-scale level L+1, and the remaining blue (B) pixels 57 are turned on with the gray-scale level L.

When the frame switches so that the frame number is ‘1’, the blue (B) pixels 57 at (0, 3), (1, 2), (2, 0), and (3, 1) are turned on with the gray-scale level L+1, and the remaining blue (B) pixels 57 are turned on with the gray-scale level L.

When the frame switches so that the frame number is ‘2’, the blue (B) pixels 57 at (0, 0), (1, 1), (2, 3), and (3, 2) are turned on with the gray-scale level L+1, and the remaining blue (B) pixels 57 are turned on with the gray-scale level L.

When the frame switches so that the frame number is ‘3’, the blue (B) pixels 57 at (0, 2), (1, 3), (2, 1), and (3, 0) are turned on with the gray-scale level L+1, and the remaining blue (B) pixels 57 are turned on with the gray-scale level L.

If the frame further switches, the frame number returns to ‘0’, and the blue (B) pixels 57 are turned on as in the case where low-order two bits of display data are ‘00’ and the frame number is ‘0’.

As such, when low-order two bits of display data are ‘00’, the pixel block 52 composed of 16 blue (B) pixels 57 displays blue (B) with a gray-scale level L+¼, which is an intermediate gray-scale level between the gray-scale levels L and L+1.

Similarly, when low-order two bits of display data are ‘01’, the pixel block 52 composed of 16 blue (B) pixels 57 displays blue (B) with a gray-scale level L+½, which is an intermediate gray-scale level between the gray-scale levels L, and L+1.

Similarly, when low-order two bits of display data are ‘10’, the pixel block 52 composed of 16 blue (B) pixels 57 displays blue (B) with a gray-scale level L+¾, which is an intermediate gray-scale level between the gray-scale levels L and L+1.

Similarly, when low-order two bits of display data are ‘11’, the pixel block 52 composed of 16 blue (B) pixels 57 displays blue (B) with the gray-scale level L+1.

As such, the electro-optical device 1 switches a lighting pattern for each frame so as to perform FRC, thereby displaying blue (B) with an intermediate gray-scale level between the gray-scale levels L and L+1. In the lighting pattern, the 16 blue (B) pixels 57 included in the pixel block 52 are turned on with the gray-scale levels L and L+1.

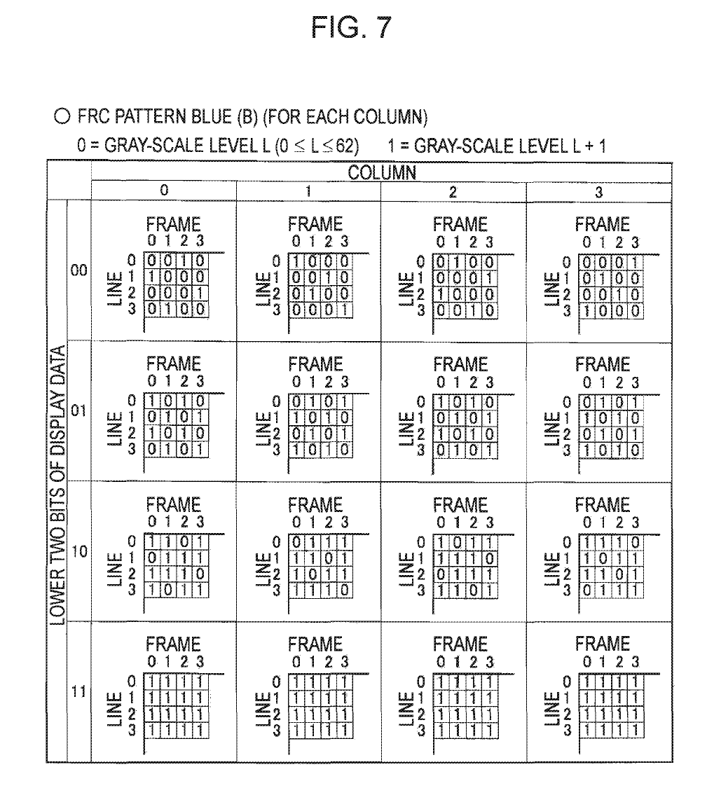

FIG. 7 is a view schematically illustrating a lighting pattern of 16 blue (B) pixels 57 among the pixels 57 included in the pixel block 52, for each column.

The 16 blue (B) pixels 57 are represented for each frame in FIG. 6, while the 16 blue (B) pixels 57 are represented for each column in FIG. 7.

In FIG. 7, the vertical axis indicates four (zeroth to third) columns by column number.

The pixel block 52 of FIG. 7 includes 16 (4×4) blue (B) pixels 57 represented by four (zeroth to third) lines and four (zeroth to third) columns.

Hereinafter, positions of these 16 blue (B) pixels 57 within the pixel block 52 are represented by [x, y] (x is the frame number, and y is the line number). In the pixel block 52, one-grayscale display is made by selectively lighting up the 16 blue (B) pixels 57.

As described above, even though the representation method is different, FIGS. 6 and 7 represent the same lighting pattern on the 16 blue (B) pixels 57.

In FIG. 7, when low-order two bits of display data are ‘00’ and the frame number is ‘0’, the blue (B) pixels 57 at [0, 1], [1, 3], [2, 0], and [3, 2] are turned on with the gray-scale level L+1. The positions of these pixels 57 respectively correspond to (0, 1) when low-order two bits of display data are ‘00’ and the frame number is ‘0’, (0, 3) when low-order two bits of display data are ‘00’ and the frame number is ‘1’, (0, 0) when low-order two bits of display data are ‘00’ and the frame number is ‘2’, and (0, 2) when low-order two bits of display data are ‘00’ and the frame number is ‘3’, in FIG. 6.

As described above, when low-order two bits of display data are ‘00’ and the frame number is ‘0’, the pixels 57 at (0, 0), (1, 1), (2, 3), and (3, 2) among the 16 red (R) pixels 57 are turned on with the gray-scale level K+1 and the remaining red (R) pixels 57 are turned on with the gray-scale level K, as shown in FIG. 4.

Furthermore, as shown in FIG. 6, the pixels 57 at (0, 1), (1, 0), (2, 2), and (3, 3) among the 16 blue (B) pixels 57 are turned on with the gray-scale level L+1 and the remaining blue (B) pixels 57 are turned on with die gray-scale level L.

Furthermore, when the frame number is ‘2’, the pixels 57 at (0, 1), (1, 0), (2, 2), and (3, 3) among the 16 red (R) pixels 57 are turned on with the gray-scale level K+1, and the remaining red (R) pixels 57 are turned on with the gray-scale level K as shown in FIG. 4.

Furthermore, as shown in FIG. 6, the pixels 57 at (0, 0), (1, 1), (2, 3), and (3, 2) among the 16 blue (B) pixels 57 are turned on with the gray-scale level L+1, and the remaining blue (B) pixels 57 are turned on with the gray-scale level L.

Therefore, when the frame number is ‘0’ or when the frame number is ‘2’, the red (R) pixels 57 and the blue (B) pixels 57 are displayed with the gray-scale levels being switched.

Therefore, the pixels 57 at (0, 0) and (1, 1) among the 16 red (R) pixels 57 of FIG. 4 and the pixels 57 at (0, 1) and (1, 0) among the 16 blue pixels 57 of FIG. 6 are adjacent to each other and have phases opposite to each other at a spatial frequency. Further, the pixels 57 at (2, 3) and (3, 2) among the 16 red (R) pixels 57 of FIG. 4 and the pixels 57 at (2, 2) and (3, 3) among the 16 blue pixels 57 of FIG. 6 are adjacent to each other and have phases opposite to each other at a spatial frequency.

As described above, the electro-optical device 1 performs FRC on the 16 red (R) pixels 57 and the 16 blue (B) pixels 57 by using the lighting pattern that is determined such that two kinds of pixels have phases opposite to each other at a spatial frequency.

Next, the FRC performed on green (G) pixels 57 and cyan (C) pixels 57 by the display gray-scale level control circuit 96 will be described.

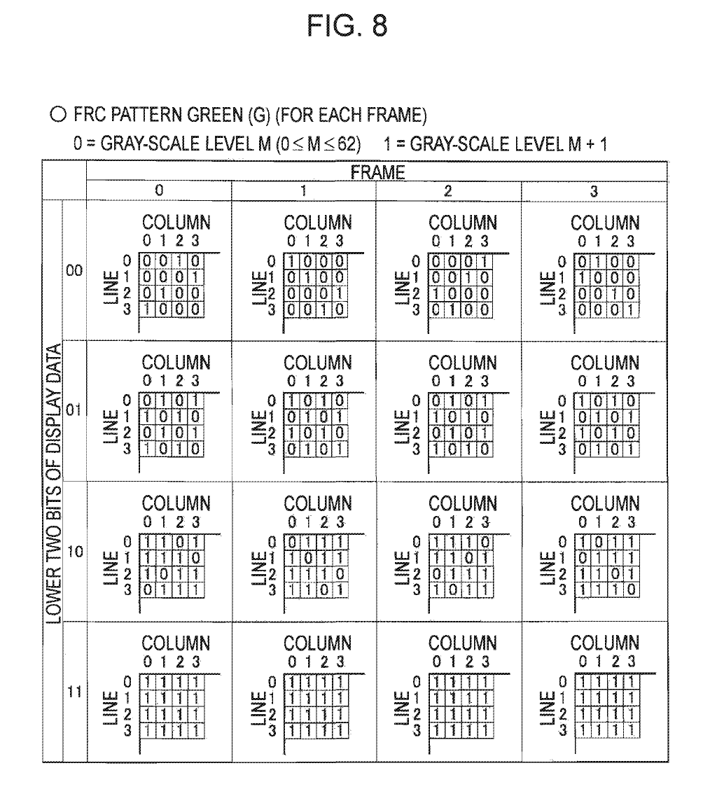

FIG. 8 is a view schematically illustrating a lighting pattern of 16 green (G) pixels 57 among the pixels 57 included in the pixel block 52, for each frame.

In FIG. 8, the vertical axis indicates a gray-scale level represented by using low-order two bits of 8-bit display data.

On the other hand, the horizontal axis indicates the frame number. IF the frame number counts up to ‘3’ from ‘0’ It returns to ‘0’.

The pixel block 52 of FIG. 8 includes 16 (4×4) green (G) pixels 57 represented by four (zeroth to third) lines and four (zeroth to third) columns.

Hereinafter, positions of these 16 green (G) pixels 57 within the pixel block 52 are represented by (x, y) (x is the column number, and y is the line number). In the pixel block 52, one-grayscale display is made by selectively lighting up the 16 green (G) pixels 57.

In the pixel block 52, the pixel 57 of ‘0’ is turned on with a gray-scale level M (here, 0≦M≦62), and the pixel 57 of ‘1’ is turned on with a gray-scale level M+1.

For example, when low-order two bits of display data are ‘10’ and the frame number is ‘0’, the 16 green (G) pixels 57 of the pixel block 52 are turned on as follows.

That is, the green (G) pixels 57 at (0, 3), (1, 2), (2, 0), and (3, 1) are turned on with the gray-scale level M, and the remaining green (G) pixels 57 are turned on with the gray-scale level M+1.

When the frame switches so that the frame number is ‘1’, the green (G) pixels 57 at (0, 0), (1, 1), (2, 3), and (3, 2) are turned on with the gray-scale level M, and the remaining green (G) pixels 57 are turned on with the gray-scale level M+1.

When the frame switches so that the frame number is ‘2’, the green (G) pixels 57 at (0, 2), (1, 3), (2, 1), and (3, 0) are turned on with the gray-scale level M, and the remaining green (G) pixels 57 are turned on with the gray-scale level M+1.

When the frame switches so that the frame number is ‘3’, the green (G) pixels 57 at (0, 1), (1, 0), (2, 2), and (3, 3) are turned on with the gray-scale level M, and the remaining green (G) pixels 57 are turned on with the gray-scale level M+1.

If the frame further switches, the frame number returns to ‘0’, and the green (G) pixels 57 are turned on as in the case where low-order two bits of the display data are ‘10’ and the frame number is ‘0’.

As such, when low-order two bits of display data are ‘10’, the pixel block 52 composed of 16 green (G) pixels 57 displays green (G) with a gray-scale level M+¾, which is an intermediate gray-scale level between the gray-scale levels M and M+1.

Similarly, when low-order two bits of display data are ‘00’, the pixel block 52 composed of 16 green (G) pixels 57 displays green (G) with a gray-scale level M+¼, which is an intermediate gray-scale level between the gray-scale levels M and M+1.

Similarly, when low-order two bits of display data are ‘01’, the pixel block 52 composed of 16 green (G) pixels 57 displays green (G) with a gray-scale level M+½, which is an intermediate gray-scale level between the gray-scale levels M and M+1.

Similarly, when low-order two bits of display data are ‘11’, the pixel block 52 composed of 16 green (G) pixels 57 displays green (G) with the gray-scale level M+1.

As such, the electro-optical device 1 switches a lighting pattern for each frame so as to perform FRC, thereby displaying green (G) with an intermediate gray-scale level between the gray-scale levels M and M+1. In the lighting pattern, the 16 green pixels 57 included in the pixel block 52 are turned on with the gray-scale levels M and M+1.

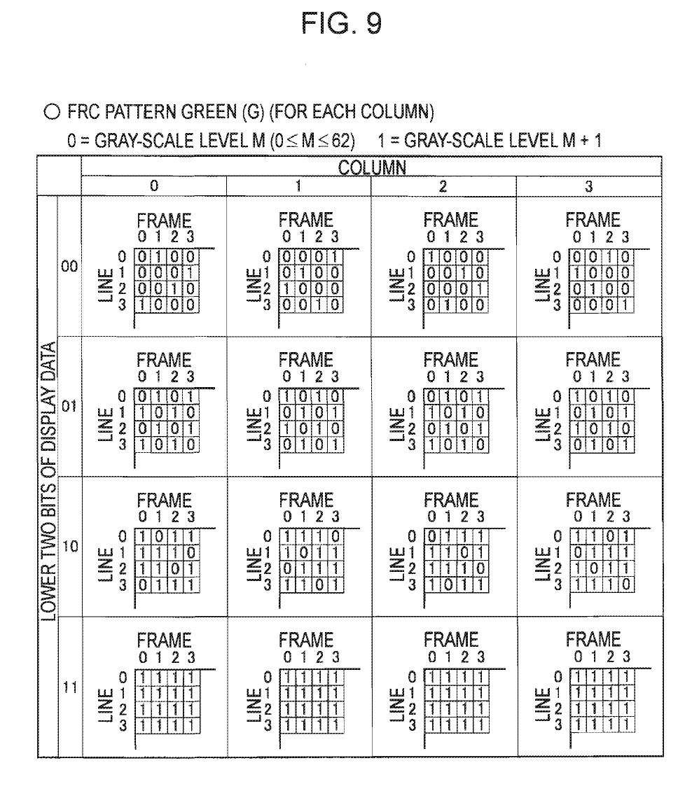

FIG. 9 is a view schematically illustrating a lighting pattern of the 16 green (G) pixels 57 among the pixels 57 included in the pixel block 52, for each column.

The 16 green (G) pixels 57 have been represented for each frame in FIG. 8, while the 16 green (G) pixels 57 are represented for each column in FIG. 9.

In FIG. 9, the vertical axis indicates four (zeroth to third) columns by the column number.

The pixel block 52 of FIG. 9 includes 16 (4×4) green (G) pixels 57 represented by four (zeroth to third) lines and four (zeroth to third) columns.

Hereinafter, positions of these 16 green (G) pixels 57 within the pixel block 52 are represented by [x, y] (x is the frame number, and y is the line number). In the pixel block 52, one-grayscale display is made by selectively lighting up the 16 green (G) pixels.

As described above, even though the representation method is different, FIGS. 8 and 9 represent the same lighting pattern on the 16 green (G) pixels 57.

In FIG. 9, when low-order two bits of display data are ‘10’ and the column number is ‘0’, the green (G) pixels 57 at [0, 3], [1, 0], [2, 2], and [3, 1] are turned on with the gray-scale level M. The positions of these pixels 57 respectively correspond to (0, 3) when low-order two bits of display data are ‘10’ and the frame number is ‘0’, (0, 0) when low-order two bits of display data are ‘10’ and the frame number is ‘1’, (0, 2) when low-order two bits of display data are ‘10’ and the frame number is ‘2’, and (0, 1) when low-order two bits of display data are ‘10’ and the frame number is ‘3’, in FIG. 8.

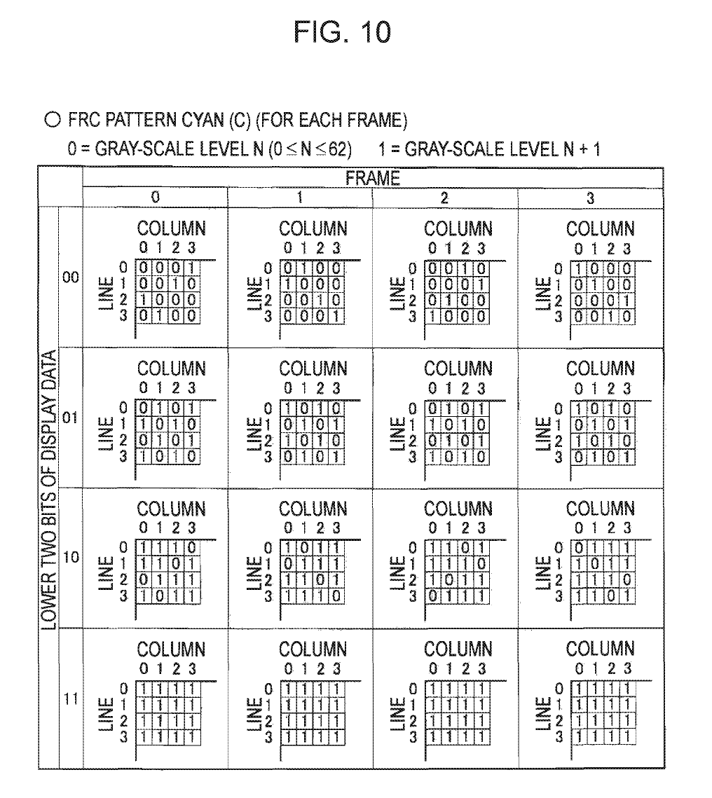

FIG. 10 is a view schematically illustrating a lighting pattern of 16 cyan (C) pixels 57 among the pixels 57 included in the pixel block 52, for each frame.

In FIG. 10, the vertical axis indicates a gray-scale level represented by using low-order two bits of 8-bit display data, and the horizontal axis indicates the frame number, similar to FIG. 8. The frame number is synchronized with the frame number of FIG. 8.

The pixel block 52 of FIG. 10 includes 16 (4×4) cyan (C) pixels 57 represented by four (zeroth to third) lines and four (zeroth to third) columns.

Hereinafter, positions of these 16 cyan (C) pixels 57 within the pixel block 52 are represented by (x, y) (x is the column number, and y is the line number). In the pixel block 52, one-grayscale display is made by selectively lighting up the 16 cyan (C) pixels 57.

In the pixel block 52, the pixel 57 of ‘0’ is turned on with a gray-scale level N (here, 0≦N≦62), and the pixel 57 of ‘1’ is turned on with a gray-scale level N+1.

For example, when low-order two bits of display data are ‘10’ and the frame number is ‘0’, 16 cyan (C) pixels 57 of the pixel block 52 are turned on as follows.

That is, the cyan (C) pixels 57 at (0, 2), (1, 3), (2, 1) and (3, 0) are turned on with the gray-scale level N, and the remaining cyan (C) pixels 57 are turned on with the gray-scale level N+1.

When the frame switches so that the frame number is ‘1’, the cyan (C) pixels 57 at (0, 1), (1, 0), (2, 2), and (3, 3) are turned on with the gray-scale level N, and the remaining cyan (C) pixels 57 are turned on with the gray-scale level N+1.

When the frame switches so that the frame number is ‘2’, the cyan (C) pixels 57 at (0, 3), (1, 2), (2, 0), and (3, 1) are turned on with the gray-scale level N, and the remaining cyan (C) pixels 57 are turned on with the gray-scale level N+1.

When the frame switches so that the frame number is ‘3’, the cyan (C) pixels 57 at (0, 0), (1, 1), (2, 3), and (3, 2) are turned on with the gray-scale level N, and the remaining cyan (C) pixels 57 are turned on with the gray-scale level N+1.

If the frame further switches, the frame number returns to ‘0’, and the cyan (C) pixels 57 are turned on as in the case where low-order two bits of the display data are ‘10’ and the frame number is ‘0’.

As such, when low-order two bits of display data are ‘10’, the pixel block 52 composed of 16 cyan (C) pixels 57 displays cyan (C) with a gray-scale level N+¾, which is an intermediate gray-scale level between the gray-scale levels N and N+1.

Similarly, when low-order two bits of display data are ‘01’, the pixel block 52 composed of 16 cyan (C) pixels 57 displays cyan (C) with a gray-scale level N+¼, which is an intermediate gray-scale level between the gray-scale levels N and N+1.

Similarly, when low-order two bits of display data are ‘01’, the pixel block 52 composed of 16 cyan (C) pixels 57 displays cyan (C) with a gray-scale level N+½, which is an intermediate gray-scale level between the gray-scale levels N and N+1.

Similarly, when low-order two bits of display data are ‘11’, the pixel block 52 composed of 16 cyan (C) pixels 57 displays cyan (C) with the gray-scale level N+1.

As such, the electro-optical device 1 switches a lighting pattern for each frame so as to perform FRC, thereby displaying cyan (C) with an intermediate gray-scale level between the gray-scale levels N and N+1. In the lighting pattern, the 16 cyan (C) pixels 57 included in the pixel block 52 are turned on with the gray-scale levels N and N+1.

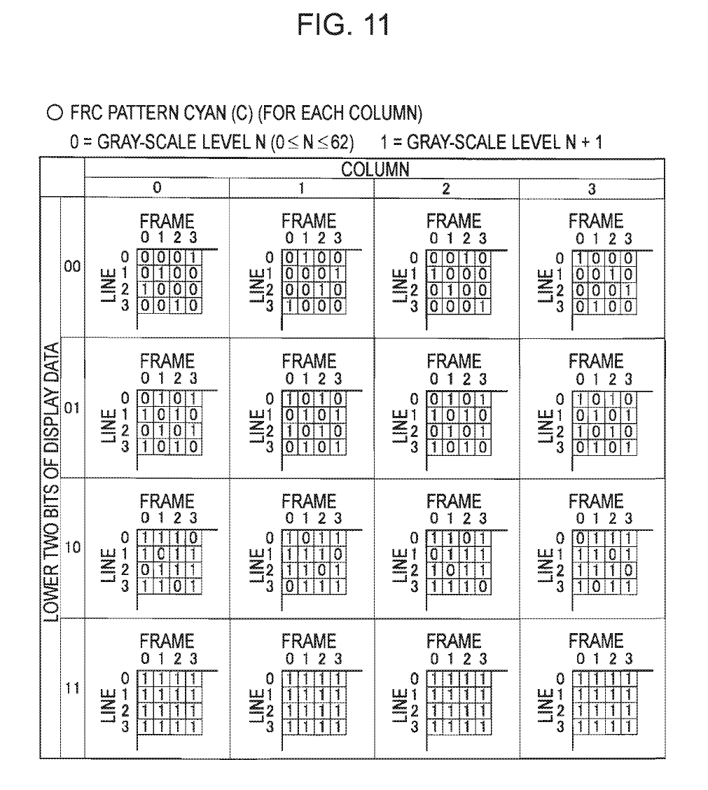

FIG. 11 is a view schematically illustrating a lighting pattern of 16 cyan (C) pixels 57 among the pixels 57 included in the pixel block 52, for each column.

Although the 16 cyan (C) pixels 57 have been represented for each frame in FIG. 10, the 16 cyan (C) pixels 57 are represented for each column in FIG. 11.

In FIG. 11, the vertical axis indicates four (zeroth to third) columns by the column number.

The pixel block 52 of FIG. 11 includes 16 (4×4) cyan (C) pixels 57 represented by four (zeroth to third) lines and four (zeroth to third) columns.

Hereinafter, positions of these 16 cyan (C) pixels 57 within the pixel block 52 are represented by [x, y] (x is the frame number, and y is the line number). In the pixel block 52, one-grayscale display is made by selectively lighting up the 16 cyan pixels 57.

As described above, even though the representation method is different, FIGS. 10 and 11 represent the same lighting pattern on the 16 cyan (C) pixels 57.

In FIG. 11, when low-order two bits of display data are ‘10’ and the column number is ‘0’, the cyan (C) pixels 57 at [0, 2], [1, 1], [2, 3], and [3, 0] are turned on with the gray-scale level N. The positions of these pixels 57 respectively correspond to (0, 2) when low-order two bits of display data are ‘10’ and the frame number is ‘0’, (0, 1) when low-order two bits of display data are ‘10’ and the frame number is ‘1’, (0, 3) when low-order two bits of display data are ‘10’ and the frame number is ‘2’, and (0, 0) when low-order two bits of display data are ‘10’ and the frame number is ‘3’, in FIG. 10.

When low-order two bits of display data are ‘10’ and the frame number is ‘0’, the pixels 57 at (0, 3), (1, 2), (2, 0), and (3, 1) among the 16 green (G) pixels 57 are turned on with the gray-scale level M, and the remaining green (G) pixels 57 are turned on with the gray-scale level M+1, as shown in FIG. 8.

Further, the pixels 57 at (0, 2), (1, 3), (2, 1), and (3, 0) among the 16 cyan (C) pixels 57 are turned on with the gray-scale level N, and the remaining cyan (C) pixels 57 are turned on with the gray-scale level N+1, as shown in FIG. 10.

Furthermore, when the frame number is ‘2’, the pixels 57 at (0, 2), (1, 3), (2, 1), and (3, 0) among the 16 green (G) pixels 57 are turned on with the gray-scale level M, and the remaining green (G) pixels 57 are turned on with the gray-scale level M+1, as shown in FIG. 8.

Furthermore, the pixels 57 at (0, 3), (1, 2), (2, 0), and (3, 1) among the 16 cyan (C) pixels 57 are turned on with the gray-scale level N, and the remaining cyan (C) pixels 57 are turned on with the gray-scale level N+1, as shown in FIG. 10).

Therefore, when the frame number is ‘0’ or when the frame number is ‘2’, the green (G) pixels 57 and the cyan (C) pixels 57 are displayed with the gray-scale levels being switched.

Therefore, the pixels 57 at (0, 3) and (1, 2) among the 16 green (G) pixels 57 of FIG. 8 and the pixels 57 at (0, 2) and (1, 3) among the 16 cyan (C) pixels 57 of FIG. 10 are adjacent to each other and have phases opposite to each other at a spatial frequency. Further, the pixels 57 at (2, 0) and (3, 1) among the 16 green (G) pixels 57 of FIG. 8 and the pixels 57 at (2, 1) and (3, 0) among the 16 cyan (C) pixels 57 of FIG. 10 are adjacent to each other and have phases opposite to each other at a spatial frequency.

As described above, the electro-optical device 1 performs FRC on the 16 green (0) pixels 57 and the 16 cyan (C) pixels 57 by using the lighting pattern that is determined so that two kinds of pixels have phases opposite to each other at a spatial frequency.

According to the present embodiment, the following effects are obtained.

(1) In the electro-optical device 1, the plurality of pixels 57 includes the pixel 57 having a red (R) color filter, the pixel 57 having a green (G) color filter, the pixel 57 having a blue (B) color filter, and the pixel 57 having a cyan (C) color filter. Further, the respective pixels 57 are displayed with a first or second gray-scale level for each frame forming a reference frame. Therefore, in terms of the reference frame, an intermediate gray-scale level between the first and second gray-scale levels can be displayed, and accordingly, the color reproducibility can be improved.

(2) Image signals are supplied to the plurality of data lines 20 such that the pixels adjacent to each other among the pixels 57 having a red (R) color filter and a blue (B) color filter have phases opposite to each other at a spatial frequency. Further, image signals are supplied to the plurality of data lines 20 such that the pixels adjacent to each other among the pixels 57 having a green (G) color filter and a cyan (C) color filter have phases opposite to each other. Therefore, the pixels 57 having a red (R) color filter and a blue (B) color filter as well as the pixels 57 having a green (G) color filter and a cyan (C) color filter can cancel each other so as to suppress flickering and irregular coloring from occurring.

Modifications

The invention is not limited to the above embodiment, and modifications and improvements within the range where the purpose of the invention can be accomplished are included in the invention.

For example, four kinds of pixels 57 Included in the pixel block 52 may be turned on in a pattern where red (R), blue (B), green (G), and cyan (C) colors can be canceled, without being limited to the lighting pattern shovel in the present embodiment.

In the present embodiment, the plurality of pixels 57 includes the pixels 57 having a red (R) color filter, a green (G) color filter, a blue (B) color filter, and a cyan (C) color filter, but are not limited thereto.

For example, the above-described red (R), blue (B), green (G), and cyan (C, may be applied to a red-base colored region (R), a blue-base colored region (B), and colored regions (G and C) of two colors selected from colors ranging from blue to yellow, respectively.

The four colored regions includes the blue-base colored region, the red-base colored region, and the colored region corresponding to two kinds of colors selected from colors ranging from blue to yellow, in a visible light region (380 to 780 nm) where color changes according to a wavelength. In this case, the blue-base color is not limited to pure blue color, but includes blue-purple, blue-green, and so on. Further, the red-base color is not limited to red, but also Includes orange. These colored regions may include a single colored layer or may include a plurality of colored layers having different colors. Further, in these colored regions, colors can be set such that the saturation and brightness thereof can be properly adjusted.

Specifically, the color range of the blue-base colored region is from blue-purple to blue-green, more preferably, from indigo to blue, and the color range of the red-base colored region is from indigo to red.

The color range of one colored region selected from colors ranging from blue to yellow is from blue to green, more preferably, from blue-green to green.

The color range of the other colored region selected from colors ranging from blue to yellow is from green to orange, more preferably, from green to yellow. Alternatively, the color range can be from green to yellow-green.

Here, the respective colored regions do not use the same color. For example, when a green-base color is used in two colored regions selected from colors ranging from blue to yellow, one colored region uses a blue-base or yellow-base color other than the green of the other colored region.

Accordingly, it is possible to realize a wider range of color reproducibility than in a known RGB colored region.

The wide range of color reproducibility has been described on the basis of a color. Hereinafter, however, the wide range of color reproducibility is presented on the basis of a wavelength of light being transmitted through a colored region, as another specific example.

In the blue-base colored region, the peak wavelength is within a range of 415 to 500 nm, or preferably, 435 to 485 nm.

In the red-base colored region, the peak wavelength is more than 600 nm, or preferably, more than 605 nm.

In one colored region selected among colors from blue to yellow, the peak wavelength is within a range of 485 to 535 nm, or preferably, 495 to 520 nm.

In the other colored region selected among colors from blue to yellow, the peak wavelength is within a range of 500 to 590 nm, or preferably, 510 to 585 nm. Alternatively, the peak wavelength is within a range of 530 to 565 nm.

These wavelengths are obtained when light emitted from a lighting device passes through a color filter in the case of transmissive display and when external light is reflected in the case of reflective display.

Next, a wide range of color reproducibility is represented by using an x and y chromaticity diagram, as a further specific example.

The blue-base colored region is in x≦0.151 and y≦0.200, or preferably, in x≦0.151 and y≦0.056, or more preferably, in 0.134≦x≦0.151 and 0.034≦y≦0.200. Most preferably, the blue-base colored region is in 0.134≦x≦0.151 and 0.034≦y≦0.056.

The red-base colored region is in 0.520≦x and y≦0.360, or preferably, in 0.643≦x and y≦0.333, or more preferably, in 0.550≦x≦0.690 and 0.210≦y≦0.360. Most preferably, the red-base colored region is in 0.643≦x≦0.690 and 0.299≦y≦0.333.

One colored region selected among colors from blue to yellow is in x≦0.200 and 0.210≦y, or preferably, in x≦0.164 and 0.453≦y, or more preferably, in 0.980≦x≦0.200 and 0.210≦y≦0.759. Most preferably, the one colored region is in 0.098≦x≦0.164 and 0.453≦y≦0.759.

The other colored region selected among colors from blue to yellow is in 0.257≦x and 0.450≦y, or preferably, in 0.257≦x and 0.606≦y, or more preferably, in 0.257≦x≦0.520 and 0.450≦y≦0.720. Most preferably, the other colored region is in 0.257≦x≦0.357 and 0.606≦y≦0.670.

Moreover, the x and y chromaticity diagram is obtained when light emitted from a lighting device passes through a colored filter in the case of transmissive display and when external light is reflected in the case of reflective display. In these four colored regions, when a sub pixel includes transmission and reflection regions, the transmission and reflection regions can also be applied within the above-described range.

As constructive examples of the above-described four-color colored regions, the following is exemplified: red, blue, green, and cyan (blue-green) colored regions; red, blue, green, and yellow colored regions; red, blue, dark green, and yellow colored regions; red, blue, emerald-green, and yellow-green colored regions; red, blue, emerald-green, and yellow colored regions; red, blue, dark green, and yellow-green colored regions; and red, blue-green, dark green, and yellow-green colored regions.

In the present embodiment, the plurality of pixels 57 include four kinds of pixels 57. Without being limited thereto, however, the plurality of pixels 57 may include three kinds or six kinds of pixels.

In the present embodiment, four kinds of pixels are arranged in a stripe pattern. Without being limited thereto, however, a mosaic arrangement or delta arrangement may be used.

In the above-described embodiment, the invention has been applied to the electro-optical device 1 using liquid crystal. Without being limited thereto, however, the invention may be applied to an electro-optical device using an electro-optical material except for liquid crystal. In the electro-optical material, optical characteristics, such as transmittance and luminance, change when an electric signal (current signal or voltage signal) is supplied. The invention can be applied to various electro-optical devices such as a display panel, an electrophoresis display panel, a twisted-ball display panel, and a plasma display panel. The display panel uses an OLED element such as organic EL (electroluminescent) or luminous polymer as an electro-optical material. The electrophoresis display panel uses microcapsule, including colored liquid and white particles dispersed in the colored liquid, as an electro-optical material. The twisted-ball display panel uses twisted balls, color-coded by a different color in each region having different polarity, as an electro-optical material. The toner display panel uses black toner as an electro-optical material. The plasma display panel uses a high-pressure gas, such as helium or neon, as an electro-optical material.

Applications

Next, an electro-optical apparatus to which the electro-optical device 1 according to the above-described embodiment is applied will be described.

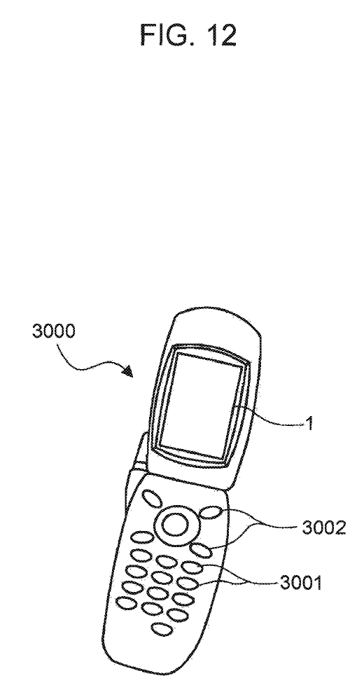

FIG. 12 is a perspective view illustrating the configuration of a mobile phone using the electro-optical device 1. The mobile phone 3000 includes a plurality of control buttons 3001 and scroll buttons 3002 and the electro-optical device 1. A screen displayed on the electro-optical device 1 is scrolled by operating the scroll buttons 3002. Further, as electronic apparatuses to which the electro-optical device 1 is applied, exemplified are a personal computer, a PDA (personal digital assistant), a digital still camera, a liquid crystal TV, a viewfinder-type or monitor-direct-view-type video tape recorder, a car navigation device, a pager, an electronic organizer, an electronic calculator, a word processor, a workstation, a video phone, a POS terminal, and a touch panel, in addition to the mobile phone shown in FIG. 12. Further, as a display unit of these electronic apparatuses, the above-described electro-optical device can be applied.

The entire disclosure of Japanese Patent Application Nos: 2005-264866, filed Sep. 13, 2005 and 2005-302777, filed Oct. 18, 2005 are expressly incorporated by reference herein.

What is claimed is:

1. An electro-optical device comprising:
scanning lines;
data lines; and
pixels that are provided at positions corresponding to intersections of the scanning lines and the data lines, the pixels including a pixel having a red color filter and a pixel having a blue color filter,
wherein frames are set as a reference frame,
the pixels are displayed with a first gray-scale or a second gray-scale whose level is higher than that of the first gray-scale by one gray-scale level, in each frame, and
image signals are supplied to the data lines such that adjacent pixels have phases opposite to each other at a spatial frequency among the pixel having the red color filter and the pixel having the blue color filter.

2. Ban electro-optical device comprising:
scanning lines;
data lines; and
pixels that are provided at positions corresponding to intersections of the scanning lines and the data lines, the pixels including a pixel having a green color filter and a pixel having a cyan color filter,
wherein frames are set as a reference frame,
the pixels are displayed with a first gray-scale or a second gray-scale whose level is higher than that of the first gray-scale by one gray-scale level, in each frame, and
image signals are supplied to the data lines such that adjacent pixels have phases opposite to each other at a spatial frequency among the pixel having the green color filter and the pixel having the cyan color filter.

3. The electro-optical apparatus according to claim 2,
wherein the pixels further include a pixel having a red color filter and a pixel having a blue color filter, and
image signals are supplied to the data lines such that adjacent pixels have phases opposite to each other at a spatial frequency among the pixel having the red color filter and the pixel having the blue color filter.

4. An electro-optical device comprising:
scanning lines;
data lines; and
pixels that are provided at positions corresponding to intersections of the scanning lines and the data lines, the pixels including pixels having color filters with colored regions corresponding to two colors selected from colors ranging from blue to yellow,
wherein frames are set as a reference frame,
the pixels are displayed with a first gray-scale or a second gray-scale whose level is higher than that of the first gray-scale by one gray-scale level, in each frame, and
image signals are supplied to the data lines such that adjacent pixels have phases opposite to each other at a spatial frequency among the pixels each having one of the color filters with one of the colored regions corresponding to the two colors and the pixels each having the other color filter with the other one of the colored regions corresponding to the two colors.

5. The electro-optical device according to claim 4,
wherein the pixels further include a pixel having a color filter with a red-base colored region and a pixel having a color filter with a blue-base colored region, and
image signals are supplied to the data lines such that adjacent pixels have phases opposite to each other at a spatial frequency among the pixel having the color filter with the red-base colored region and the pixel having the color filter with a blue-base colored region.

6. An electronic apparatus comprising the electro-optical device according to claim 1.

7. A method of driving an electro-optical device having scanning lines, data lines, and pixels that are provided at positions corresponding to intersections of the scanning lines and the data lines and include a pixel having a red color filter and a pixel having a blue color filter, the method comprising:
supplying image signals to the data lines such that adjacent pixels have phases opposite to each other at a spatial frequency among the pixel having the red color filter and the pixel having the blue color filter,
wherein frames are set as a reference frame, and
the pixels are displayed with a first gray-scale or a second gray-scale whose level is higher than that of the first gray-scale by one gray-scale level, in each frame.

8. A method of driving an electro-optical device having scanning lines, data lines, and pixels that are provided at positions corresponding to intersections of the scanning lines and the data lines and include a pixel having a green color filter and a pixel having a cyan color filter, the method comprising:
supplying image signals to the data lines such that adjacent pixels have phases opposite to each other at a spatial frequency among the pixel having the green color filter and the pixel having the cyan color filter,
wherein frames are set as a reference frame, and
the pixels are displayed with a first gray-scale or a second gray-scale whose level is higher than that of the first gray-scale by one gray-scale level, in each frame.

9. The method of driving an electro-optical device according to Claim B,
wherein the pixels further include a pixel having a red color filter and a pixel having a blue color filter, and
image signals are supplied to the data lines such that adjacent pixels have phases opposite to each other at a spatial frequency among thea pixel having the red color filter and the pixel having the blue color filter.

10. A method of driving an electro-optical device having scanning lines, data lines, and pixels that are provided at positions corresponding to intersections of the scanning lines and the data lines and include pixels having color filters with colored regions corresponding to two colors selected from colors ranging from blue to yellow, the method comprising:
supplying image signals to the data lines such that adjacent pixels have phases opposite to each other at a spatial frequency among the pixels each having one of the color filters with one of the colored regions corresponding to the two colors and the pixels each having the other color filter with the other one of the colored regions corresponding to two colors,
wherein frames are set to a reference frame, and
the pixels are displayed with a first gray-scale or a second gray-scale whose level is higher than that of the first gray-scale by one gray-scale level, in each frame.

11. The method of driving an electro-optical device according to claim 10,
wherein the pixels further include a pixel having a color filter with a red-base colored region and a pixel having a color filter with a blue-base colored region, and
image signals are supplied to the data lines such that adjacent pixels have phases opposite to each other at a spatial frequency among the pixel having the color filter with a red-base colored region and the pixel having the color filter with a blue-base colored region.
